(19) United States
(12) Patent Application Publication
(10) Pub. No.: US 2002/0052726 A1
(43) Pub. Date: May 2, 2002

(54) Performance simulation apparatus, performance simulation method, and recording medium containing performance simulation program

(75) Inventors: Satoshi Tajima, Kawasaki-Shi (JP); Masato Igarashi, Yachiyo-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 09/984,616

(22) Filed: Oct. 30, 2001

(30) Foreign Application Priority Data
Oct. 31, 2000 (JP) 2000-332261

(51) Int. Cl. G06F 9/45

(52) U.S. Cl. 703/22

(57) ABSTRACT

According to the present invention, it is possible to easily execute a performance simulation of a system in which a real-time OS is installed. In a performance simulation apparatus for executing a performance simulation of a system, in which a real-time OS is installed, by the use of a software simulation model 2 having a real-time OS model 3 and an application model 4 having at least one task, the real-time OS model 3 has a plurality of components each including at least one function selecting item for specifying the function. The performance simulation apparatus also has a selector 6 configured to select at least part of the function selecting items to specify the functions of the real-time OS model.

### CROSS REFERENCE TO RELATED APPLICATION

This application is based upon and claims the benefit of priority from the prior Japanese Patent Applications No. 2000-332261, filed on Oct. 31, 2000; the entire contents of which are incorporated herein by reference.

### BACKGROUND OF THE INVENTION

1. Field of the Invention

The present invention relates to a performance simulation apparatus and a performance simulation method for executing a performance simulation of systems installed real-time operating systems (OSs), which are widely used in the fields of household electrical appliances, office equipment, etc. The present invention also relates to a recording medium containing performance simulation program.

2. Related Background Art

Generally, systems widely used for household electrical appliances, office equipment, etc. are installed systems consisting of hardware and software. In order to design such systems, it is necessary to meet the requirements of the specifications of both hardware design and software design. Conventionally, inspections and estimations through simulations of the accuracy of designs or the optimization of architecture of designs have been conducted based on intuitions and experiences of skilled systems designers. However, as the performance of computers has improved, such systems have become large-scaled and complicated. Accordingly, verifications and/or estimations of the performance of a system during an initial stage of the process of system design have become rather difficult.

Further, recently, systems in which real-time OSs (Operating Systems) are installed for supporting multitasking operations have prevailed in order to execute system control operations requiring large-scale and complicated real-time processing operations. Such installed systems are widely used. At present, various kinds of real-time OSs are in the market, and many applications developed by using such real-time OSs appear on the market. Thus, real-time OSs play important roles in the field of installed systems. However, in an initial stage of a system design process, it often happens that the detailed specification of the system has not yet been decided. In such a case, it is not easy to inspect and estimate the performance of the system through a performance simulation since the details of the real-time operating system, such as what kind of real-time operating system is used, what kind of scheduling method or queuing method is used, etc. have not yet been decided. Moreover, since various kinds of real-time operations systems have appeared, it takes much time to create a real-time OS model for the use in a performance simulation, and the modification of a simulation model due to the modification of the system specification is not easy.

Thus, in the conventional installed system designs, it has not been easy to create a simulation model for the performance simulation of a real-time OS, etc, in an initial stage of a design process. Further, it has not been easy to change/modify the simulation model due to the change in the system specification. Moreover, it has not been easy to carry out a performance simulation in a stage where no specific real-time OS or the function thereof has yet been decided.

### SUMMARY OF THE INVENTION

The present invention is proposed taking the above-described problems into consideration. Accordingly, the object of the present invention is to provide a performance simulation apparatus, a performance simulation method, and a recording medium containing performance simulation program, with which it is possible to easily carry out a performance simulation of a system in which a real-time OS is installed.

A performance simulation apparatus according to a first aspect of the present invention comprises: a real-time OS model having a plurality of components each having at least one function selecting item for specifying the function of the real-time OS; an application model including at least one task; a function selector configured to select at least part of the function selecting items to specify the functions of the real-time OS model; and simulator configured to execute a simulation of a system, in which a real-time OS is installed, by using the real-time OS model specified by the function selector and the application model.

Further, the task may be sent and received between the components by the simulator.

Still further, the task may be described by a state transition model, and a state transition operation of the task may be executed by service call.

Moreover, the performance simulation apparatus may further comprise a hardware simulation model, and the simulator may execute a hardware/software cooperating simulation (so-called “co-simulation”) by using the hardware simulation model, the real-time OS model, and the application model.

A performance simulation apparatus according to a second aspect of the present invention comprises: a plurality of real-time OS models each having a plurality of functions; an application model having at least one task; a common real-time OS model former configured to select common functions which are common to the real-time OS models, and to form a common real-time OS model having the common functions; and simulator configured to execute a simulation of a system, in which a real-time OS is installed, by the use of the common real-time OS model and the application model.

At least part of the functions of the common real-time OS model may be selectable.

Further, the performance simulation apparatus may further comprise a hardware simulation model, and the simulator may execute a co-simulation by using the hardware simulation model, the common real-time OS model, and the application model.

Still further, at least one of processing method, queue size, and semaphore number may be set to the component by specifying the function selecting items.

Moreover, the real-time OS model may be adjusted to represent functions of a real-time OS by a combination of components each having any of scheduling function, queuing function, semaphore function, dispatch function, and service call function.

The component may be adjusted to set a queuing algorithm by specifying the function selecting items.

The component may be adjusted to set a round-robin function by comparing a timeslice period value of the real-time OS set by specifying the function selecting items and a CPU occupation time value of the task.

The real-time OS model may comprise a task data storing function and be adjusted to change the task data.

The component may render selectable any of a binary semaphore, a counting semaphore, and an mutual exclusion semaphore by specifying the function selecting items.

Further, the simulator may switch between the plurality of real-time OS models by specifying the function selecting items to execute a simulating operation.

A performance simulation method according to the present invention comprises: reading functions of a real-time OS; selecting a function selecting item of a real-time OS model including a plurality of components each having at least one function selecting item for specifying the function of the real-time operating system; specifying a component based on the result of the selecting; forming a software simulation model by combining the specified component and an application model having at least one task; and executing the software simulation model.

A recording medium according to the present invention contains a performance simulation program instructions for: reading functions of a real-time OS; selecting a function selecting item of a real-time OS model including a plurality of components each having at least one function selecting item for specifying the function of the real-time OS; specifying a component based on the result of the selecting step; forming a software simulation model by combining the specified component model and an application model having at least one task; and executing the software simulation model.

### BRIEF DESCRIPTION OF THE DRAWINGS

FIG. 1 is a block diagram showing the architecture of a performance simulation apparatus according to a first embodiment of the present invention.

FIG. 2 is a table showing the relationships between the functions and the function selecting items of a real-time OS.

FIG. 3 is a diagram showing a real-time OS model constituted by combining the functions of a real-time OS.

FIG. 4 is a diagram showing an example of the queuing function of a real-time OS represented as components, each dealing with a certain state of a task.

FIG. 5 is a diagram showing the semaphore function of a real-time OS represented as components for certain function selecting items.

FIG. 6 is a diagram showing the structure of a task used for a first embodiment of the present invention.

FIG. 7 is a block diagram showing an example of a combination of functions of a real-time OS represented as components, according to the first embodiment of the present invention.

FIG. 8 is a flow chart showing the task processing of the real-time OS model according to the first embodiment of the present invention.

FIG. 9 is a flow chart showing the processing of an application model described in a state transitional manner.

FIG. 10 is a diagram showing the process of constituting a common real-time OS model according to the first embodiment of the present invention.

FIG. 11 is a flow chart showing the process of a performance simulation method according to a second embodiment of the present invention.

FIG. 12 is a block diagram showing the architecture of a performance simulation apparatus according to a third embodiment of the present invention.

FIG. 13 is a block diagram showing an example of the process of selecting resources in the performance simulation apparatus according to the third embodiment of the present invention.

FIG. 14 is a block diagram showing the architecture of a real-time OS model having a function for storing task data in a performance simulation apparatus according to a fourth embodiment of the present invention.

FIG. 15 is a flow chart showing the process of storing task data of the real-time OS model according to the fourth embodiment of the present invention.

FIG. 16 is a perspective view of a computer system using a recording medium containing a performance simulation program according to the present invention.

FIG. 17 is a block diagram showing an example of a computer system using a recording medium containing the performance simulation program according to the present invention.

### DESCRIPTION OF THE EMBODIMENTS

Hereinafter, embodiments of the present invention will be described with reference to the accompanying drawings.

(First Embodiment)

A first embodiment of the present invention will be described with reference to FIGS. 1-10. FIG. 1 shows the architecture of the first embodiment, i.e., a performance simulation apparatus for carrying out a performance simulation of a system in which a real-time OS is installed. In FIG. 1, a performance simulation apparatus 1 includes a software simulation model 2 having a real-time OS model 3 and an application model 4, function selector 6, and simulator 8.

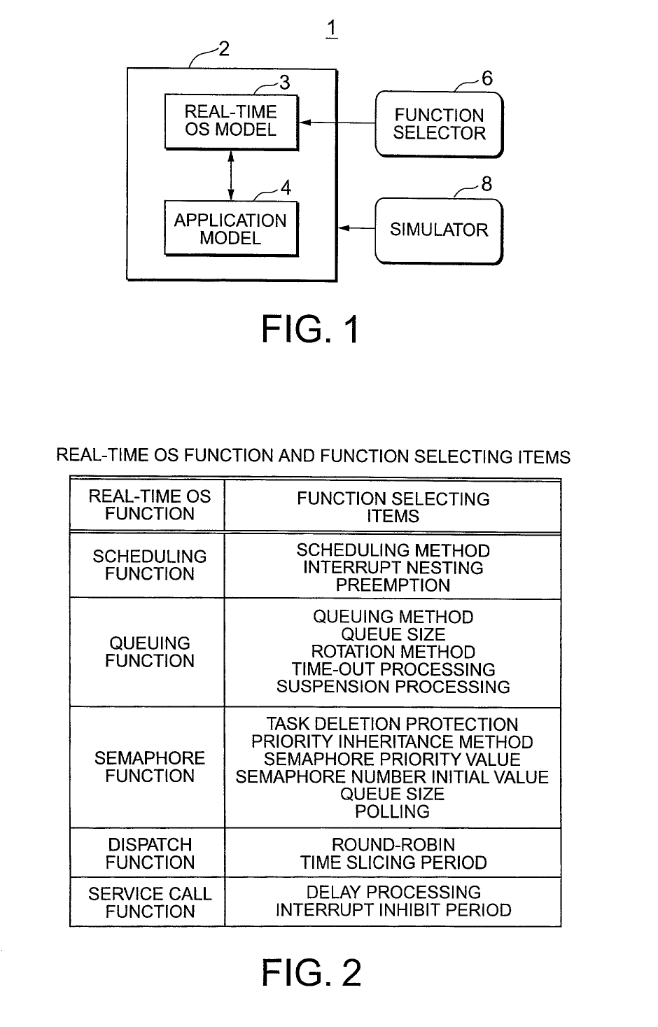

The real-time OS model 3 has a plurality of functions. For example, as shown in FIG. 2, it has a scheduling function, a queuing function, a semaphore function, a dispatch function, and a service call function. In addition, as shown in FIG. 2, each function includes at least one function selecting item for specifying the function.

The scheduling function includes function selecting items such as Scheduling Method, Interrupt Nesting, Preemption, etc. Scheduling Method is a method for selecting tasks assigned to a CPU, based on the priority levels of the tasks, or in a FIFO (First In First Out) manner. Interrupt Nesting is a processing method dealing with interrupts from external devices, and decides an interrupt nesting method when the CPU is in an interrupt inhibit state. Preemption is an item for deciding whether scheduling processing is executed or not when a task having a higher priority level than the task now being executed is in an executable state.

The queuing function includes function selecting items such as Queuing Method, Queue Size, Rotation Method, Time-out Processing, Suspension Processing, etc., as shown in FIG. 2. Queuing Method is a method for connecting a task to a queue based on the priority level of the task, or in a FIFO manner. Queue Size is the upper limit of the number of tasks inserted in a queue. Rotation Method is a method for changing the order of tasks in a queue. Time-out Processing relates to a processing operation for taking a task out of a queue after a predetermined length of time. Suspension Processing relates to forcibly bringing a task in a queue into a waiting state.

The semaphore function includes function selecting items such as Task Deletion Protection, Priority Inheritance Method, Semaphore Priority Value, Semaphore Number Initial Value, Queue size, Polling, etc, as shown in FIG. 2. Task Deletion Protection is an item for inhibiting the deletion of a task having obtained a semaphore. Priority Inheritance Method is an item relating to a method for temporarily changing the priority level of a task having obtained a semaphore. Semaphore Priority Value is a value of the priority level of semaphore; if the priority level of a task having obtained a semaphore is lower than that of the semaphore itself, the priority level of the task is temporarily changed to the same level as the semaphore. Semaphore Number Initial Value is an initial value of a semaphore. Queue Size is an upper limit of the number of tasks that can be inserted into a queue a semaphore has. Polling is a processing method for processing a task having failed to obtain a semaphore.

As shown in FIG. 2, the dispatch function includes function selecting items such as Round-robin, Timeslicing Period, etc. Round-robin relates to a round-robin method regarding CPU assignment. Timeslicing Period relates to a round-robin method, and deals with time intervals for executing the round-robin method.

The service call function includes function selecting items such as Delay Processing, Interrupt Inhibit Period, etc., as shown in FIG. 2. Delay Processing relates to delay processing when a service call is executed. This item relates to a method such as for processing interrupt inhibit, etc. Interrupt Inhibit Period relates to interrupt inhibit processing, and to interrupt inhibit time.

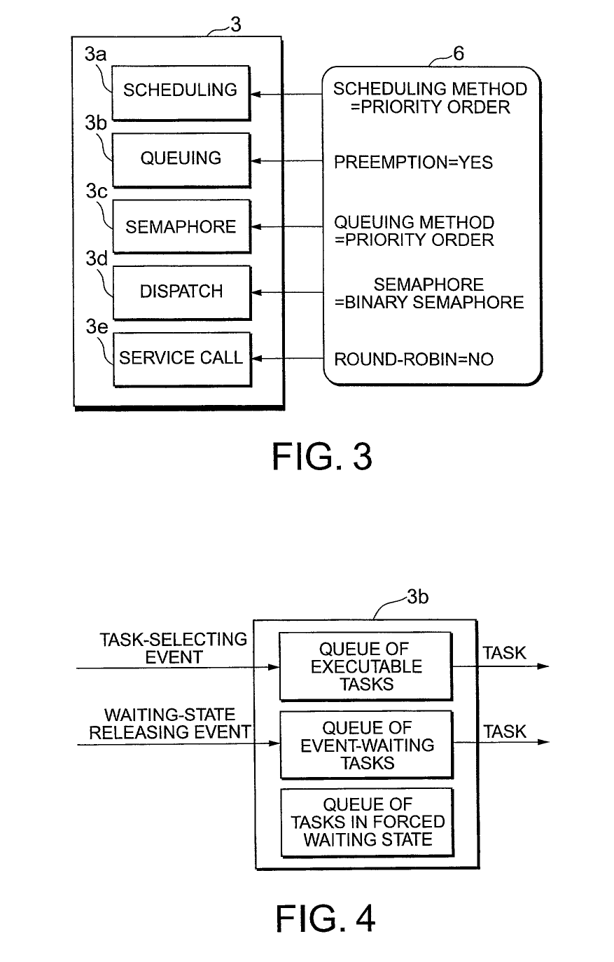

Turning back to FIG. 1, the application model 4 is composed of at least one task. The function selector 6 specifies functions of, e.g., the real-time OS model 3 having such functions as a scheduling function 3a, a queuing function 3b, a semaphore function 3c, a dispatch function 3d, and a service call function 3e, as shown in FIG. 3, by selecting at least part of the function selecting items based on externally input information (information including function selecting items). It is possible to adjust the setting so that all of the function selecting items may be selected. Alternatively, part of items may be specified in advance.

A performance simulation is executed by the simulator 8 based on the functions specified by the function selector 6 and the application model 4.

Next, the architecture of the function-selectable real-time OS model 3 will be described. FIG. 3 shows the architecture of the function-selectable real-time OS model 3 including some components each representing a specific function.

First, each function will be described.

The scheduling function 3a is a function for executing task scheduling. When a scheduling executing event is received as an input, a scheduling method is decided in view of the function selecting items of the scheduling function 3a. Next, an event for selecting a task to be executed from the queuing function 3b is outputted. For example, if the scheduling method is set to be the priority order scheduling method by the function selector 6, an event for the priority order scheduling is outputted. It may be possible for the scheduling function 3a to output an event for executing a preemption of a task by determining whether or not the item Preemption exists in function selecting items.

The queuing function 3b is a function for queuing a non-executable task. When a task represented as a data structure is received as an input, a queuing method is determined in view of the function selecting items of the queuing function 3b to queue the task. For example, if a queuing method is arranged to be the priority order of queuing methods by the function selector 6, the priority level of the task is determined, and the queuing processing is executed by order of priority. A structure type of task will be described in detail later. It is further possible that a preempted task and a non-preempted task are queued in different locations by combining the queuing function 3b with variables to represent queuing locations of preempted tasks. Moreover, it is also possible that the number of tasks that can be queued are set by setting the size of a queue by the function selector 6.

Further, the queuing function 3b can be divided into sub-components, each dealing with a certain state of task. This will be described with reference to FIG. 4. The queuing function is divided into some sub-components representing a queue for executable tasks, a queue for event-waiting tasks, a queue for tasks forcibly brought into a waiting state, etc. In the queuing function 3b thus constituted, when a task is received as an input, the task is queued, and outputted when various input events occur. For example, on receiving an event for selecting a task from the scheduling function 3a, the queue for executable tasks checks the contents of the event, and selects and outputs a suitable task from the queue. Further, on receiving an event for releasing waiting state, the queue for event-waiting tasks checks the contents of the event, and select and outputs a suitable task from the queue.

The semaphore functions 3c is a function for performing synchronization and communication of tasks. When a task represented as a data structure is received, the existence of a semaphore is determined based on the number of semaphore. Then, the task is queued based on a queuing method, or an operation is performed on the semaphore. For example, with the assumption that the queuing method is set to be the priority order method by the function selector 6, when a task for obtaining a semaphore is received, if the number of the semaphore is a positive number, the number is decremented by 1, and the task is outputted. If the number of the semaphore is 0, the task is queued in accordance with its priority level.

Moreover, a binary semaphore function, a counting semaphore function, and an mutual exclusion semaphore function can be selected for the semaphore function 3b by the function selector 6. For example, if the function selector 6 sets the initial value of the number of semaphore to be “1”, the semaphore becomes a binary semaphore; if the initial value is set to be “2” or more, the semaphore becomes a counting semaphore. Further, it is possible to set a deletion protecting function on a task having obtained a semaphore. Moreover, it is possible to set an mutual exclusion semaphore priority inheritance function.

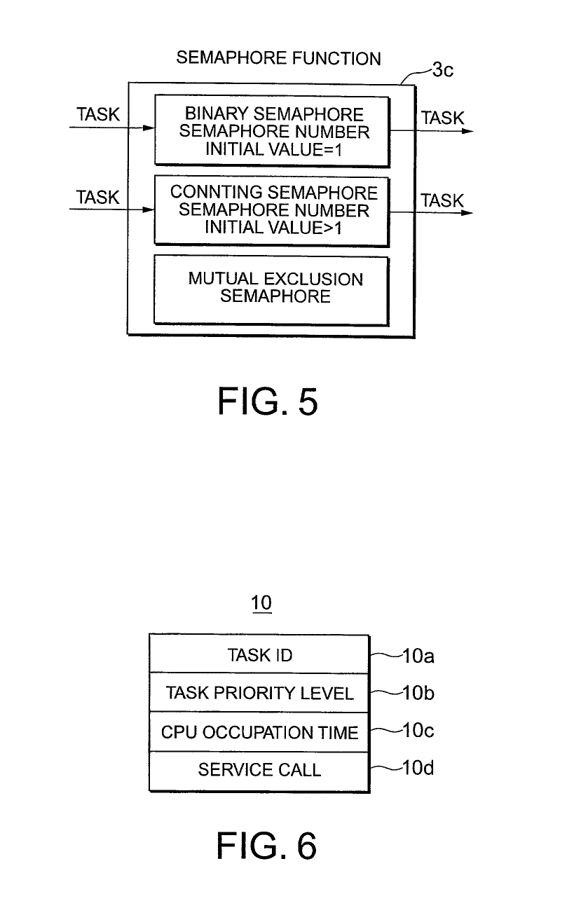

The semaphore functions 3c can be divided into some sub-components, each representing a certain semaphore function. This will be described with reference to FIG. 5. The semaphore function 3c can be divided into sub-components such as a binary semaphore having the fixed initial value of “1”, a counting semaphore having the fixed initial value of “2” or more, an mutual exclusion semaphore, etc.

The dispatch function 3d is a function for assigning a task to the CPU. For example, when a task represented as a data structure is received as an input, the value of CPU occupation time of the task is determined, and the task is assigned to the CPU for that time. After that,the occupation of the CPU is terminated, and the task is outputted. If a preemptive event is received while the task is being assigned to the CPU, the CPU occupation time of the task is modified, and the task is outputted. It is possible to ignore the preemptive event by setting the preemption function of the dispatch function 3d by the function selector 6.

Further, the function selector 6 can set a round-robin function on the dispatch function 3d. For example, when a task is received as an input, the CPU occupation time value of the task and the timeslice value of the round-robin function are compared. If the timeslice value is smaller than the CPU occupation time value of the task, the CPU occupation time of the task is modified, and the task is assigned to the CPU. When the task completes the occupation of the CPU, the task is outputted as an executable task to the queuing function 3b. Thus, it is possible to execute a round-robin function by the use of the function selector 6.

The service call function 3e is a function executing, with respect to service calls of tasks, a task control function by the use of a real-time OS, a task-dependent synchronization function, a task synchronization/communication function, a time control function, etc. For example, with the assumption that a service call of a task represented as a data structure requires a task deletion, when the task is received as an input, a target task is retrieved from a queue by the queuing function 3b, and an event for deleting the task from the queue is outputted. If a task service call requires a semaphore operation, the task is outputted to the semaphore function 3c. When the service call processing is completed, an event for scheduling the task is outputted.

Next, the architecture of a real-time OS model obtained by combining the above-described functions will be described.

Component models for executing simulations of the above-described functions are registered in the real-time OS model 3. Such components models may be either prepared in advance, or newly created. The functions of such component models in the real-time OS model 3 are selected and set by the use of the function selector 6. Further, it is possible to decide whether such components are used or not.

Next, the structure type of a task processed in a real-time OS model constituted by combining the above-described component models will be described with reference to FIG. 6.

FIG. 6 shows the structure of a task 10 represented as a data structure. The task 10 includes a task ID number 10a, a task priority level 10b, a task CPU occupation time 10c, and a task service call name 10d. These task data items are set in advance by the application model 4, and based on these task data items the real-time OS model 3 executes the task scheduling operation, the queuing control operation, etc. Further, by adding another data item to the task structure shown in FIG. 6, it is possible to utilize various functions of the real-time OS. For example, if the task deletion protection function of the real-time OS is intended to be used, a task deletion protection data item is added to the task data items. Then, the task deletion protection operation is executable when the real-time OS model 3 recognizes this data item. Thus, by showing a task as a data structure, it is possible to easily utilize various real-time OS functions. Moreover, it is possible to easily create or modify the application model 4.

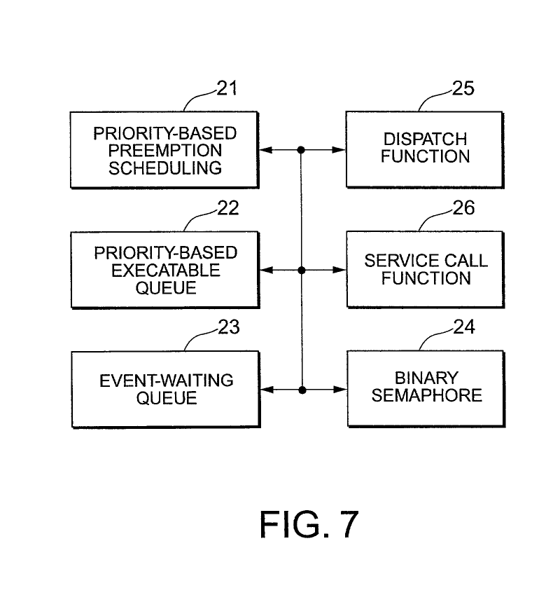

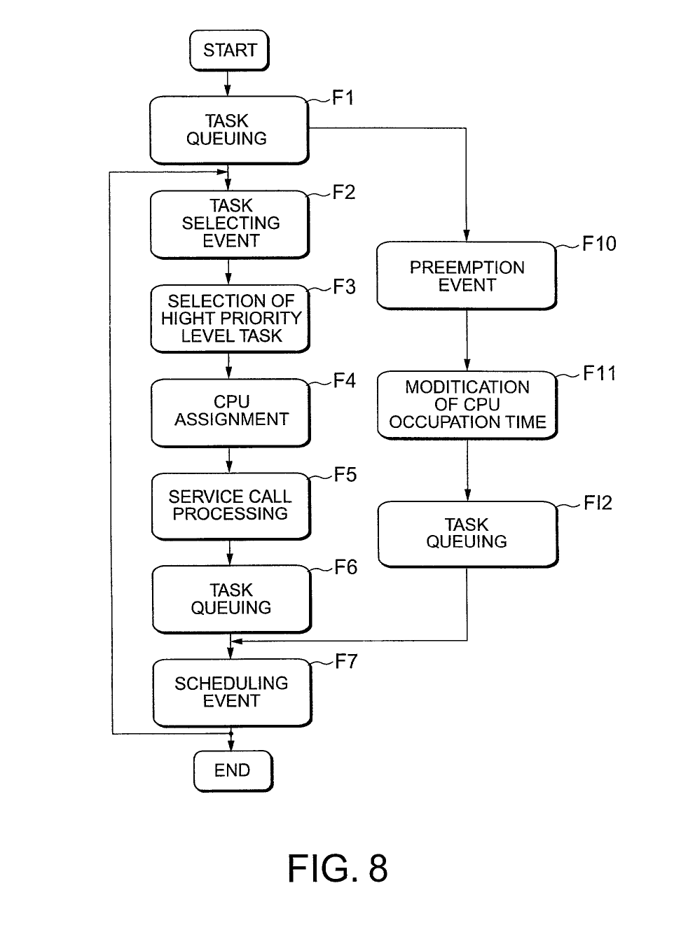

Next, the operations of the real-time OS model 3 realized by combining the above-described component models will be described with reference to FIGS. 7 and 8.

FIG. 7 shows the architecture of a real-time OS model 3 realized by combining the components having the above-described functions. FIG. 8 is a flow chart showing the task processing operations performed on the real-time OS model. In FIG. 7, a component 21 includes the scheduling function 3a. Items Priority-based Scheduling and Preemption are set to this component. A component 22 includes the queuing function 3b, and represents a queue for executable tasks, for which Priority-based Queuing is set through the setting of the function selecting items by the use of the function selector 6. A component 23 includes the queuing function 3b, and represents a queue for event-waiting tasks. A component 24 has the semaphore function 3c, and Binary Semaphore is set to this component through the setting of the function setting items by the use of the function selector 6. A component 25 has the dispatch function 3d. A component 26 has the service call function 3e.

The real-time OS model 3 realized by combining the above-described components receives a task having the structure as shown in FIG. 6, and outputs the task to the component 22 for queuing the task, as shown by step F1 of FIG. 8. If a scheduling event occurs at step F2, a task selecting event is outputted by the component 21. At step F3, the component 22 receives the event, and outputs the task with the highest priority level to the component 25. At step F4, the component 25 receives the task, and assigns the CPU to the task for the CPU occupation time the task owns. At the end of the CPU occupation by the task, the component 25 outputs the task to the component 26. At step F5, the component 26 receives the task, determines the service call of the task, and processes the service call. For example, if the service call is a semaphore obtaining service call, the task is outputted to the component 24. At step F6, the component 24 receives the task, and executes a semaphore flag operation. For example, if the number of semaphore is 0, the component 24 queues the task. At step F7, on completion of the process at step F6, the component 26 generates a scheduling event. After step F7, the process returns to step F2.

Next, the operations to be executed when the component 22 receives a task with a higher priority level, while the process at step F4 is being executed, will be described. At step F10, the component 21 outputs a preemption event. At step F11, the component 25 receives the preemption event, modifies the CPU occupation time of the task to which the CPU is being assigned, and outputs the task to the component 22. At step F12, the component 22 queues the preempted task. Then, at step F7, the component 21 outputs an event for selecting a task. After that, the process returns to F2.

Thus, if the real-time OS model 3 is divided into several components, each representing a certain function, it is possible to easily constitute various kinds of real-time OS models by combining such components and setting the function selecting items of the functions. Further, since various kinds of real-time OS functions can be selected by setting the function selecting items, it is possible to execute a performance simulation of a system without creating a new real-time OS model, or modifying a currently existing real-time OS model. For example, if a real-time OS model is created such that one of three different types of real-time OS models can be selected, it is possible to execute a performance simulation with each real-time OS model, and decide which type of real-time OS should be embedded in the system based on the simulation results.

Next, the description of the application model 4 for using the real-time OS model 3 formed by combining the above-describe components will be explained.

The application model 4 consists of a plurality of tasks utilizing the real-time OS model 3. Each task is described as having one or more states for every service call. A transition of a state is performed each time the CPU occupation time is consumed within the real-time OS model 3, and a service call of the real-time OS model 3 is used.

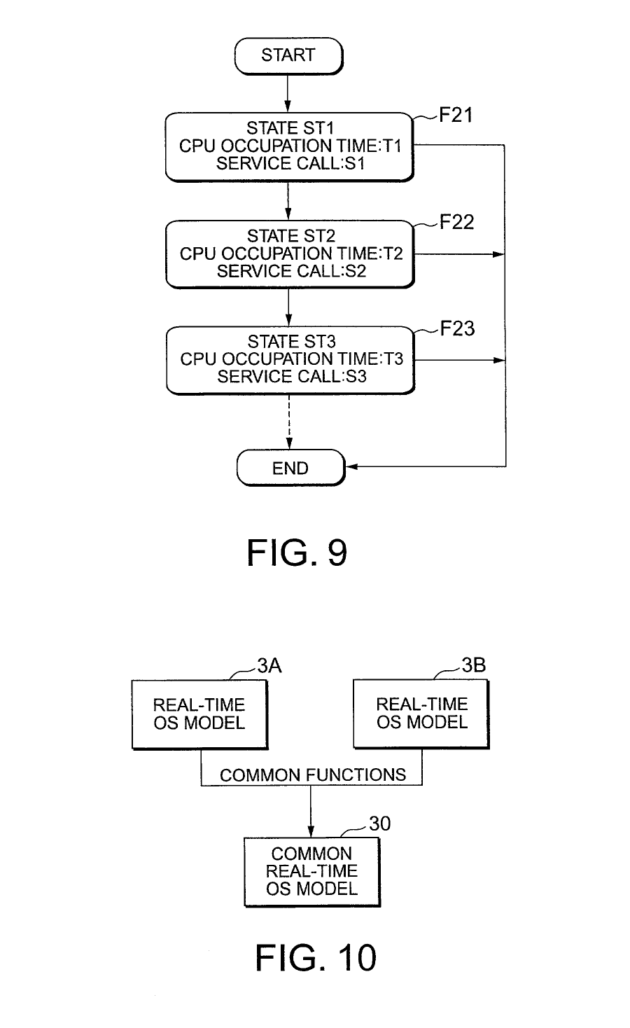

FIG. 9 is a flow chart showing a task having a plurality of states each being for a service call. At step F21, the task is in an initial state ST1, having a CPU occupation time T1 and a service call S1. At step F22, the task is in a state ST2, having a CPU occupation time T2 and a service call S2. At step F23, the task is in a state ST3, having a CPU occupation time T3 and a service call S3.

The operations of the application model 4 will be described next. When the task is in the state ST1, the CPU occupation time and the service call of the task are set to be T1 and ST1, respectively, and the task data is outputted to the real-time OS model 3. The real-time OS model 3 receives the task data, and executes the processing as shown in FIG. 8 (step F21). When the real-time OS model 3 completes the service call processing of the task in the state ST1, the state of the task is changed from ST1 to ST2. When the task enters the state ST2, the CPU occupation time and the service call of the task are set to be T2 and S2, respectively, and the real-time OS model 3 executes an appropriate service call processing (step F22). Thus, every time a service call processing operation is completed, the state of the task is changed from the current state STi (i=1, 2, . . . ) to the next state STi+1, and an appropriate processing operation is executed by the real-time OS model 3. In each state STi (i=1, 2, . . . ), if the task is deleted in the real-time OS model before the completion of the service call processing operation, the state of the task is not changed to the next state STi+1 but to the termination state. As shown in FIG. 9, there are a plurality of transitional states of task. Every time a service call is made, the state of the task changes.

Thus, it is possible to easily utilize the various functions of a real-time OS model in a simulation of the function-selectable real-time OS model 3 by describing the application model in a state-transition manner. Further, it is possible to easily create an application model since tasks are described in a state transition model.

Next, a method of constituting a common real-time OS model by combining the above-described components will be described.

A plurality of real-time OS models are constituted by combining the above-described components and setting the function selecting items of each component. Next, the functions of the real-time OS models are compared, and common functions are labeled as general-purpose functions. The other functions are labeled as specific functions. Then, a common real-time OS model is constituted by combining the general-purpose functions. This will be described with reference to FIG. 10. For example, it is assumed that there are a commercially-available real-time OS model 3A having the priority-based queuing function, the task preemption function, the binary semaphore function, and the task deletion protection function, and another commercially-available real-time OS model 3B having the queuing function for which either the priority-based method or the FIFO method can be selected as the queuing method, the task preemption function, the round-robin function, the binary semaphore function, and the mutual exclusion semaphore function. The common functions of the real-time OS model 3A and the real-time OS model 3B are the priority-based queuing function, the task preemption function, and the binary semaphore function. These functions can be registered as the general-purpose functions in a common real-time OS model 30.

Thus, by constituting a plurality of real-time OS models, and by comparing the functions of such models to select general-purpose functions, it is possible to easily constitute a common real-time OS model and to easily simulate such a real-time OS model. For example, even at the initial stage of the design of a system to which a real-time OS is installed, where the specification of real-time OS has not yet been decided, it is possible to estimate the performance of the system by simulating the performance by the use of the above-described common real-time OS model.

As described above, according to the performance simulation apparatus of the present invention, the functions of a real-time OS are divided into some components. By using a real-time OS model constituted by a combination of such components, it is possible to easily execute a performance simulation of a system installing various kinds of real-time operating systems.

(Second Embodiment)

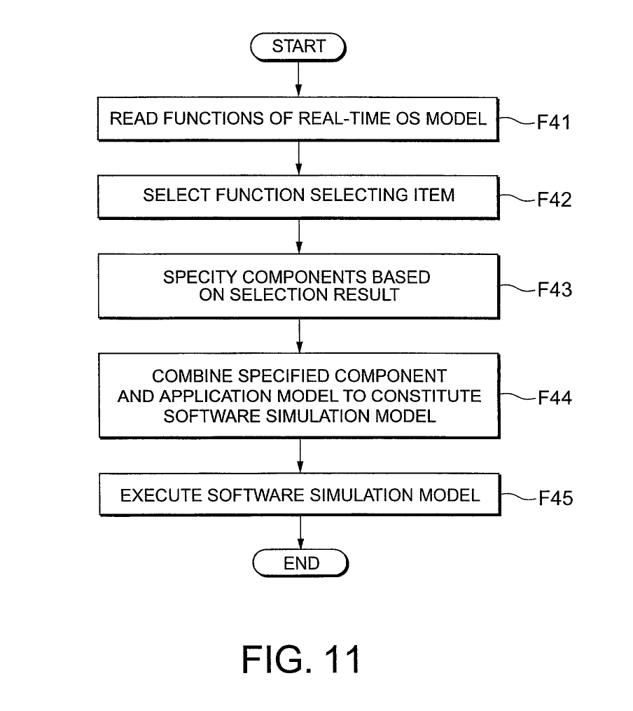

A second embodiment of the present invention will be described with reference to FIGS. 1 and 11. The second embodiment is a method of executing a performance simulation. FIG. 11 shows the process of the method.

The performance simulation method of this embodiment uses the performance simulation apparatus shown FIG. 1. The method follows the steps mentioned below. First, at step F41 of FIG. 11, the function selector 6 reads functions of a real-time OS model having a plurality of functions, each being specified by at least one function selecting item. Then, at step F42, the function selector 6 selects at least part of the function selecting items. At step F43, component models are specified in the real-time OS model 3 based on the functions selected in the above step. At step F44, a software simulation model 2 is constituted by combining the specified component models and an application model. At step F45, the simulator 8 executes the software simulation model 2.

According to the performance simulation method of this embodiment, it is possible to execute a performance simulation of a system in which a real-time OS is installed.

(Third Embodiment)

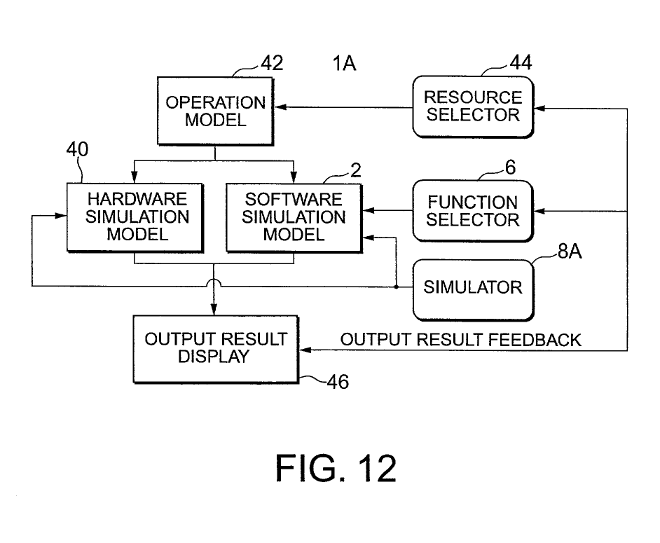

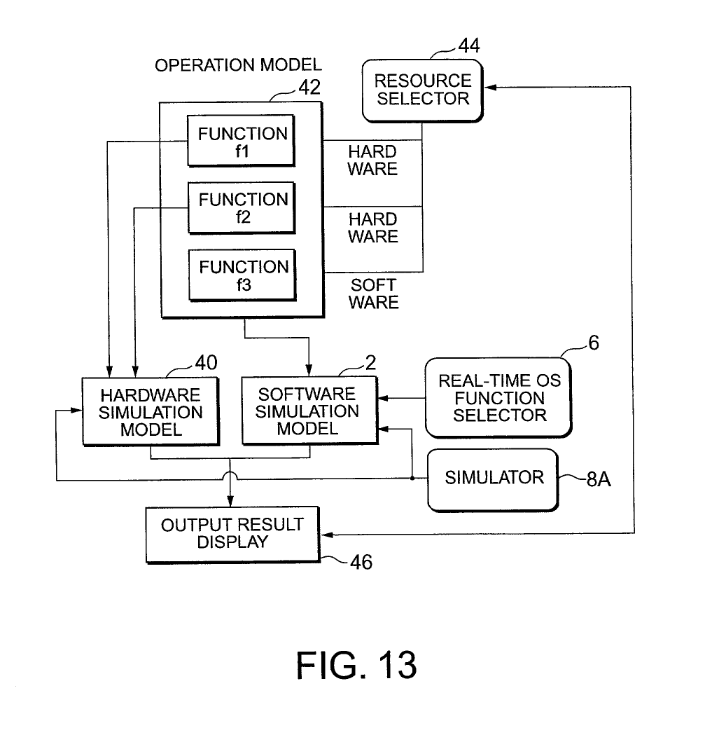

A third embodiment of the present invention will be described with reference to FIGS. 12 and 13. The third embodiment is a performance simulation apparatus for executing a performance simulation of a system in which a real-time OS is installed. FIG. 12 shows the architecture of this apparatus. A performance simulation apparatus 1A includes a software simulation model 2 having a real-time OS model 3 and an application model 4, function selector 6, simulator 8A, a hardware simulation model 40, an operation model 42, a resource selector 44, and output result display 46.

The performance simulation apparatus 1A of this embodiment is obtained by replacing the simulator 8 of the performance simulation apparatus 1 of the first embodiment shown in FIG. 1 with the simulator 8A, and by adding the hardware simulation model 40, the operation model 42, the resource selector 44, and the output result display 46. This performance simulation apparatus 1A executes a hardware/software cooperating simulation (so-called “co-simulation”) by the use of a function-selectable real-time OS model.

In FIG. 12, the operation model 42 is an operation model of a system in which a real-time OS model is embedded. It includes a function of executing processing as software, and a function of executing processing as hardware. The output result display 46 displays the output result of simulations.

The resource selector 44 partitions the functions of the operation model 42 among the software and hardware resources. The simulator 8A executes the simulations of the functions, which the resource selector 44 selected to be run on the software resources, through the software simulation model 2, and executes the simulations of the functions, which were selected to be run on the hardware resources, through the hardware simulation model 40. For example, with reference to FIG. 13, the operation model 42 includes functions f1, f2, and f3. The resource selector 44 selects hardware resources for the functions f1 and f2, and a software resource for the function f3. In such a case, when a simulation is executed, the hardware simulation model 40 processes the functions f1 and f2, and the software simulation model 2 processes the function f3. If the resource selector 44 is adjusted to select a software recourse for the function f1 and hardware resources for the functions f2 and f3, it is possible to execute a simulation of a different function-partitioning case. It is further possible to compare and study the simulation results of various function-partitioning cases by the use of the output result display 46.

Next, the operations of this embodiment will be described.

The resource selector 44 partitions the hardware/software functions of the operation model 42. When a simulation is executed, the functions of the operation model 42 to execute processing as hardware are simulated by the hardware simulation model 40, and the functions to execute processing as software are simulated by the software simulation model 2.

Then, the function selector 6 selects the functions of the real-time OS model. As mentioned in the descriptions of the first embodiment, it is possible to constitute a plurality of real-time OS models by changing the function setting of this real-time OS. Moreover, if no specific real-time OS model is decided, a common real-time OS model can be constituted by the method described above.

After the simulation is executed, the output result display 46 displays a simulation result. Further, using this result, it is possible execute a simulation of a different function-partitioning case where the functions are partitioned among the software resources and the hardware resources in a different way by the resource selector 44. Moreover, using this result, it is possible to select a different real-time OS model by the use of the function selector 6, and execute a simulation by this different real-time OS model. For example, it is possible to easily compare and study the system performances of the case where a mutual exclusion of reading from/writing to a shared memory is performed by a real-time OS having a binary semaphore, the case where the mutual exclusion is performed by a real-time OS having a counting semaphore, and the case where the mutual exclusion is performed by hardware without using a real-time OS.

Thus, with respect to hardware/software cooperating simulations, it is possible to execute performance simulations of a system regarding function assignment by using the above-described function-selectable real-time OS model.

(Fourth Embodiment)

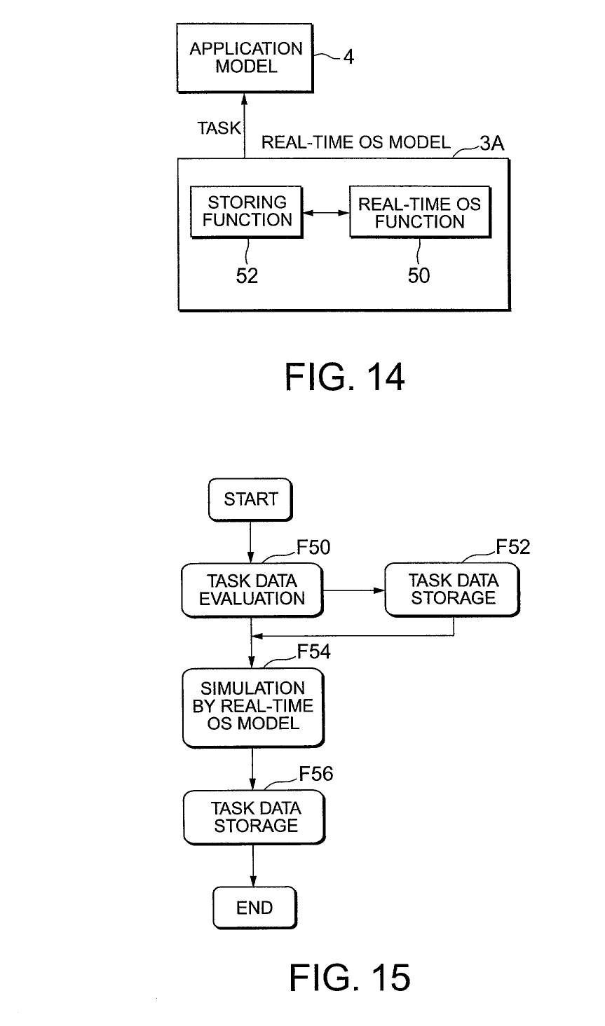

Next, a performance simulation apparatus obtained by adding a task data storing function to the above-described function-selectable real-time OS model will be described as a fourth embodiment of the present invention. The performance simulation apparatus of the fourth embodiment is obtained by replacing the simulation model of the performance simulation apparatus of the first embodiment shown in FIG. 1 with a simulation model shown in FIG. 14.

As shown in FIG. 14, the simulation model of this embodiment includes a function-selectable real-time OS model 3A and an application model 4 described as a state transition model in the explanation of the first embodiment. The real-time OS model 3A has a real-time OS function 50 and a task data storing function 52.

The operations of the simulation model shown in FIG. 14 will be described with reference to FIG. 15. When a simulation is executed, task data is sent from the application model 4 to the real-time OS model 3A. The real-time OS model 3A uses the task data storing function 52 to evaluate the received task data (step F50 of FIG. 15). If data corresponding to the received task data has already been stored in the storing function 52, the received task data is replaced with the stored data. If the received task data is not stored in the storing function 52, the received task data is stored in the storing function 52 (step F52). When the task processing in the real-time OS model 3A is completed (step F54), the task data at the time of the completion is stored in the storing function 52 (step F56).

For example, when a task including data having the priority level “2” is sent from the application model 4 to the real-time OS model 3A, the task priority level “2” of the task is stored in the storing function 52. Subsequently, the real-time OS model 3A processes the task. If the priority level of the task is changed to “3” through the task priority level modifying processing of the real-time OS model 3A, the priority level “3” is stored in the storing function 52 at the time of the completion of the processing of the task.

Thus, by adding a task data storing function to a real-time OS model, it is possible to easily execute task data modifying processing by the use of the real-time OS model. Further, it is possible to execute a system performance simulation more accurately. Moreover, since the real-time OS carries out the task data modifying processing, the application model is not required to carry out the task data modifying processing. Accordingly, it is easy to create an application model.

Also in this embodiment, it is possible to easily execute a performance simulation of a system in which a real-time OS is embedded.

(Fifth Embodiment)

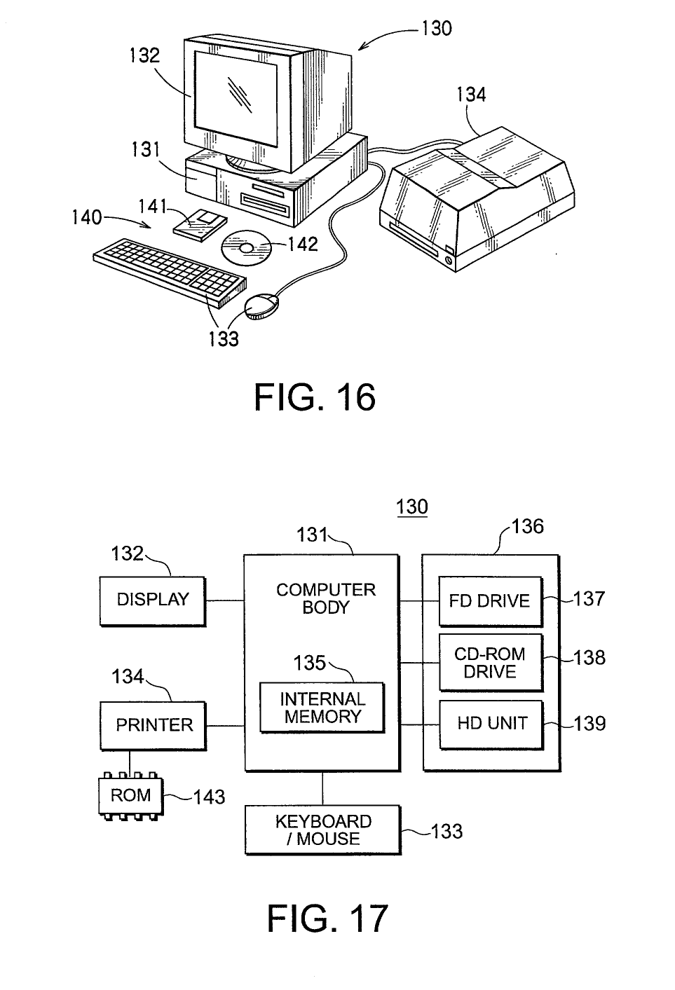

A fifth embodiment of the present invention will be described with reference to FIGS. 16 and 17. This embodiment is a recording medium containing a performance simulation program. FIGS. 16 and 17 are a perspective view and a block diagram showing an example of a computer system 130 using a recording medium containing a performance simulation program according to this embodiment.

In FIG. 16, the computer system 130 includes a computer body 131 having a CPU, a display 132 such as a CRT, an input apparatus 133 such as a keyboard and a mouse, and a printer 134 for executing printing operations.

As shown in FIG. 17, the computer body 131 includes an internal memory 135 consisting of a RAM, and a memory unit 136 which is either housed in or externally connected to the computer body 131. Examples of the memory unit 136 are a flexible or floppy disk (FD) drive 137, a CD-ROM drive 138, a hard disk (HD) drive unit 139. As shown in FIG. 16, examples of the recording medium 140 used for the memory unit 136 are a flexible or floppy disk (FD) 141 to be inserted into a slot of the FD drive 137, a CD-ROM 142 for the CD-ROM drive 138, etc.

Examples of the recording medium 140 used in a common computer system are the FD 141 and the CD-ROM 142, as shown in FIGS. 16 and 17. Of course, besides these, a MO (Magneto-Optical) disk, a DVD (Digital Versatile Disk), any other optical recording disk, a card memory, magnetic tape, etc. may also be used as a recording medium.

The recording medium 140 at least includes instructions for steps F41-F45 of the simulation process shown in FIG. 11. That is, the recording medium 140 of this embodiment includes instructions for: reading functions of a real-time OS model having a plurality of functions each being specified by at least one function selecting item; selecting the function selecting items; specifying component models from the functions based on the selection result; combining the specified component models and an application model to constitute a software simulation model; and executing the software simulation model.

As described above, according to the present invention, it is possible to execute a performance simulation of a system in which a real-time OS is embedded.

Additional advantages and modifications will readily occur to those skilled in the art. Therefore, the invention in its broader aspects is not limited to the specific details and representative embodiments shown and described therein. Accordingly, various modifications may be made without departing from the spirit or scope of the general inventive concept as defined by the appended claims and their equivalents.

What is claimed is:

1. A performance simulation apparatus configured to simulate the performance of a system in which a real-time operating system is installed, comprising:
a real-time operating system model having a plurality of components each having at least one function selecting item for specifying the function of the real-time operating system;
an application model including at least one task;
a function selector configured to select at least part of the function selecting items to specify the functions of the real-time operating system model; and
a simulator configured to execute a simulation of the system by using the real-time operating system model specified by the function selector and the application model.

2. The performance simulation apparatus according to claim 1, wherein the task is sent and received between the components by the simulator.

3. The performance simulation apparatus according to claim 2, wherein the task is described by a state transition model, and the simulator executes a state transition operation of the task by service call.

4. The performance simulation apparatus according to claim 1 further comprising a hardware simulation model, wherein the simulator executes a co-simulation by using the hardware simulation model, the real-time operating system model, and the application model.

5. The performance simulation apparatus according to claim 1, wherein at least one of processing method, queue size, and semaphore number can be set to the component by specifying the function selecting items.

6. The performance simulation apparatus according to claim 1, wherein the real-time operating system model is adjusted to represent functions of the real-time operating system by a combination of components each having any of scheduling function, queuing function, semaphore function, dispatch function, and service call function.

7. The performance simulation apparatus according to claim 1, wherein the component is adjusted to set a queuing algorithm by specifying the function selecting items.

8. The performance simulation apparatus according to claim 1, wherein the component is adjusted to set a round-robin function by comparing a timeslice period value of the real-time operating system set by specifying the function selecting items and a CPU occupation time value of the task.

9. The performance simulation apparatus according to claim 1, wherein the real-time operating system model comprises a task data storing function and is adjusted to change the task data.

10. The performance simulation apparatus according to claim 1, wherein the component render selectable any of a binary semaphore, a counting semaphore, and an mutual exclusion semaphore by specifying the function selecting items.

11. The performance simulation apparatus according to claim 1 wherein there are a plurality of real-time operating system models, and wherein the simulator switches between the plurality of real-time operating system models by specifying the function selecting items to execute the simulation.

12. A performance simulation apparatus configured to simulate the performance of a system in which a real-time operating system is installed, comprising:
a plurality of real-time operating system models each having a plurality of functions;
an application model including at least one task;
a common real-time operating system model former configured to select common functions which are common to the real-time operating system models, and to form a common real-time OS model having the common functions; and
a simulator configured to execute a simulation of a system by the use of the common real-time operating system model and the application model.

13. The performance simulation apparatus according to claim 12, wherein at least part of the functions of the common real-time operating system model is selectable.

14. The performance simulation apparatus according to claim 12 further comprising a hardware simulation model, wherein the simulator executes a co-simulation by using the hardware simulation model, the common real-time operating system model, and the application model.

15. A performance simulation method configured to simulate the performance of a system in which a real-time operating system is installed, comprising:
reading functions of a real-time operating system;
selecting a function selecting item of a real-time operating system model including a plurality of components each having at least one function selecting item for specifying the function of the real-time operating system;
specifying the component based on the result of the selecting;
forming a software simulation model by combining the specified component and an application model having at least one task; and
executing the software simulation model.

16. The performance simulation method according to claim 15, wherein the task is sent and received between the components by the executing.

17. The performance simulation method according to claim 16, wherein the task is described by a state transition model, and a state transition operation of the task is executed by service call.

18. A recording medium containing a performance simulation program instructions for:
reading functions of a real-time operating system model;
selecting a function selecting item of a real-time operating system model including a plurality of components each having at least one function selecting item for specifying the function of the real-time operating system;
specifying the component based on the result of the selecting;
forming a software simulation model by combining the specified component and an application model having at least one task; and
executing the software simulation model.

19. The recording medium according to claim 18, wherein the task is sent and received between the components by the executing.

20. The recording medium according to claim 19, wherein the task is described by a state transition model, and a state transition operation of the task is executed by service call.
